(19) United States
(12) Patent Application Publication
(10) Pub. No.: US 2015/0116440 A1
(43) Pub. Date: Apr. 30, 2015

(54) RIBBON AND PHOTOGRAPH PRINTING METHOD

(71) Applicant: HITI DIGITAL, INC., New Taipei City (TW)

(72) Inventor: Hui-Ting Yang, New Taipei City (TW)

(21) Appl. No.: 14/526,422

(22) Filed: Oct. 28, 2014

Related U.S. Application Data
(60) Provisional application No. 61/897,231, filed on Oct. 30, 2013.

(30) Foreign Application Priority Data
Sep. 10, 2014 (TW) 103131178

(51) Int. Cl. B41J 2/325

(52) U.S. Cl. CPC B41J 2/325
USPC 347/213

(57) ABSTRACT

A ribbon includes a ribbon body, a plurality of first dye regions, a second dye region and a protecting dye region. The plurality of the first dye regions are sequentially arranged on the ribbon body. The dyes of the first dye regions are able to mix with each other. The second dye is located on a side of the plurality of the first dye regions, and the second dye region is located between the protecting dye region and the plurality of the first dye regions. The dye of the second dye region is unable to mix with the dyes of the first dye regions.

### RELATED APPLICATIONS

This application claims priority to U.S. Provisional Application No. 61/897,231 filed on Oct. 30, 2013, and to Taiwan Application Serial Number 103131178, filed on Sep. 10, 2014, which is herein incorporated by reference.

### BACKGROUND

1. Field of Invention

The present invention relates to a ribbon, and more particularly, to dyes of a ribbon and to a photograph printing method that is implemented through application of such a ribbon.

2. Description of Related Art

With the advancement of technology (for example, the invention of digital cameras), people can store photos in a memory after taking pictures, and then print the stored photos through a sublimation printer or another printer that is able to print photographs. Thus, it is no longer necessary to spent time at a photo studio to develop and print photographs.

Furthermore, since the photos are stored in a memory, people can easily edit the photos, for example, by adding some lace patterns, snow patterns or star patterns to the photos stored in memory, so as to make the photos more interesting to view.

However, if the photos are printed with lace patterns, snow patterns or star patterns, much of the quality of such special effects on the photos originally shown in the digital camera will be lost. For example, a user may add some lace patterns on a stored photo, but after printing the photo, the lace patterns on the printed photo may seem as if they are a part of the original photo, and not something that has been added thereto. In other words, after a photo with such lace patterns, snow patterns or star patterns are printed, it may not be possible to distinguish between the original photo and the added patterns. Hence, the additional added patterns seem like a part of the original image, ultimately affecting the printing quality in a negative way.

### SUMMARY

According to one or more embodiments of the present disclosure, a ribbon is provided. The ribbon includes a ribbon body, a plurality of first dye regions, at least one second dye region and a protecting dye region. The plurality of the first dye regions are sequentially arranged on the ribbon body, in which dyes of the first dye regions are able to mix with each other. The second dye region is arranged on a side of the plurality of the first dye regions, in which a dye of the second dye region is unable to mix with the dyes of the first dye regions. The second dye region is disposed between the protecting dye region and the plurality of the first dye regions.

According to one or more embodiments of the present disclosure, a photograph printing method is provided. The photograph printing method includes the following steps (it should be understood that the order of the steps described in the present embodiment, unless otherwise specified, may be changed as required, or the steps or part of the steps may be performed simultaneously):
(1) Providing a ribbon. The ribbon includes a plurality of first dye regions sequentially arranged on the ribbon and at least one second dye region arranged on a side of the plurality of the first dye regions, in which dyes of the first dye regions are able to mix with each other, and a dye of the second dye region is unable to mix with the dyes of the first dye regions.
(2) Providing a printing medium.
(3) Using a thermal printing head to transfer print at least one of the dyes of the first dye regions onto the printing medium.
(4) Using the thermal printing head to transfer print the dye of the second dye region onto the printing medium.

As discussed above, a ribbon and a photograph printing method that is implemented through application of the ribbon are provided in one or more embodiments of the present disclosure. Because the dye of the second dye region is unable to mix with the dyes of the first dye regions, when the dye of the second dye region covers the dyes of the first dye regions, there is a better distinction between the dyes of the first dye regions and the dye of the second dye region. As a result, the dye of the second dye region can be used to print additional added lace patterns. After additional added lace patterns are printed by using the dye of the second dye region, the lace patterns do not appear as if they are a part of the original image, such that printing quality is enhanced.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic view of a ribbon in accordance with one embodiment of the present disclosure.

FIG. 2 is a functional block diagram of a sublimation printer in accordance with one embodiment of the present disclosure.

FIG. 3 is a schematic view of a thermal printing head shown in a state transfer printing a dye of a ribbon in accordance with one embodiment of the present disclosure.

FIG. 4 is a flow chart of a photograph printing method in accordance with one embodiment of the present disclosure.

### DETAILED DESCRIPTION

The following embodiments are disclosed with accompanying diagrams for detailed description. For illustration clarity, many details of practice are explained in the following descriptions. However, it should be understood that these details of practice do not intend to limit the present invention. That is, these details of practice are not necessary in parts of embodiments of the present invention. Furthermore, for simplifying the drawings, some of the conventional structures and elements are shown with schematic illustrations. Wherever possible, the same reference numbers are used in the drawings and the description to refer to the same or like parts.

The following embodiments relate to dyes of a ribbon and to a photograph printing method that is implemented through application of the ribbon. More specifically, the ribbon of the present disclosure contains at least two dyes with different properties, in which one of the dyes is able to be mixed with a dye of another color, and the other dye is unable to be mixed with a dye of another color, so as to achieve a special printing effect.

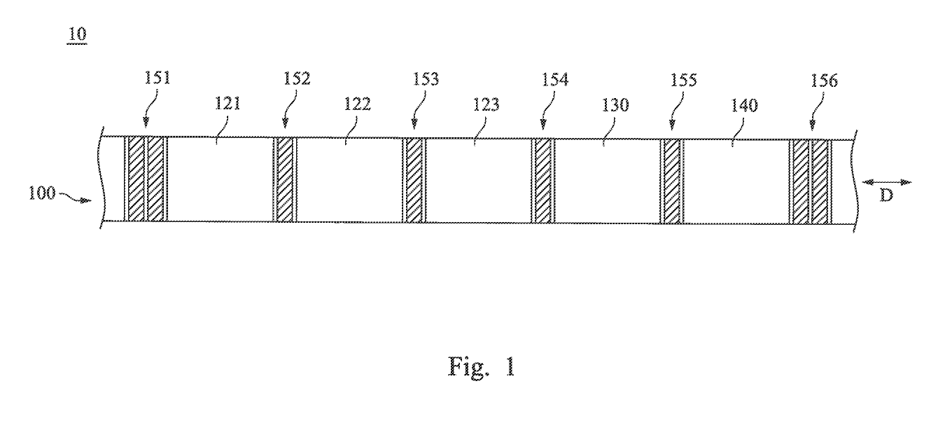

FIG. 1 is a schematic view of a ribbon 10 in accordance with one embodiment of the present disclosure. As shown in FIG. 1, the ribbon 10 includes a ribbon body 100, a plurality of first dye regions 121, 122 and 123, a second dye region 130 and a protecting dye region 140. In the present embodiment, the first dye regions 121, 122 and 123 are sequentially arranged on the ribbon body 100, and the dyes of the first dye regions 121, 122 and 123 are able to mix with each other.

For example, in some embodiments, the first dye region 121 can be a yellow dye region, the first dye region 122 can be a magenta dye region, and the first dye region 123 can be a cyan dye region. When the yellow dye, the magenta dye and the cyan dye are transfer printed onto a printing medium, the human eye perceives a full color photo after the different colors of the dyes are mixed with each other.

With continued reference to FIG. 1, the second dye region 130 is arranged on a side of the plurality of the first dye regions 121, 122 and 123. More specifically, in present embodiment, the first dye regions 121, 122 and 123 and the second dye region 130 are all disposed on the ribbon body 100 and are arranged along a direction D. The dye of the second dye region 130 is unable to mix with the dyes of the first dye regions 121, 122 and 123. Further, the dye of the second dye region 130 is adapted to cover the dyes of the first dye regions 121, 122 and 123. Since the dye of the second dye region 130 is unable to mix with the dyes of the first dye regions 121, 122 and 123, when the dye of the second dye region 130 and the dyes of the first dye regions 121, 122 and 123 are transfer printed onto the printing medium together, there is a greater distinction between the dye of the second dye region 130 and the dyes of the first dye regions 121, 122 and 123. In other words, when a user edits a photo by adding some lace patterns to the photo, the dye of the second dye region 130 can be used to print such lace patterns. Since the dye of the second dye region 130 does not mix with the dyes of the first dye regions 121, 122 and 123, the dye of the second dye region 130 does not look like a part of the original image and can emphasize the subject(s) in the photo, so as to enhance print quality.

In some embodiments, the dye of the second dye region 130 has greater gloss than the printing medium (for example, photographic paper). That is, when the dye of the second dye region 130 is transfer printed onto the printing medium, a user can immediately see the effect of the dye of the second dye region 130. Further, the material of the dye of the second dye region 130 may include metal, for example, metal particles, but the dye of the second dye region 130 is not limited in this regard. Through the high gloss and high reflectivity of the metal material, the dye of the second dye region looks more bright, and a user can see a metallic color that is similar to a metal material. For example, if the material of the dye of the second dye region 130 includes silver particles, after the dye of the second dye region 130 is transfer printed onto a printing medium and covers the dyes of the first dye regions 121, 122 and 123, a user can see a silver color. Further, through controlling the thickness or printing density of the dye of the second dye region 130, the dye of the second dye region 130 can be opaque or translucent on the printing medium so that a user can realize more visual effects when editing the stored photos, and does not have to worry that after printing the stored photos, the effect appearing when viewing the photos on the digital camera can not be shown as well after printing the stored photos.

In actual applications, the gloss of the printing medium is about 70 GU to about 90 GU. If the dye of the second dye region 130 is a silver color, i.e., the dye of the second dye region 130 includes silver particles, the gloss of the dye of the second dye region 130 is about 300 GU. If the dye of the second dye region 130 is a gold color, i.e., the dye of the second dye region includes gold particles, the gloss of the dye of the second dye region 130 is about 145 GU.

It should be understood that, although in above embodiments, the dye of the second dye region 130 is described as having a silver color, in other embodiments, the dye of the second dye region 130 can have other colors such as a gold, red or black color. Further, the dye of the second dye region 130 is not limited to being made of a silver paste or another metal paste, but a gold leaf or silver leaf configuration may be used for the dye of the second dye region 130.

Further, although there is only one second dye region 130 in the above embodiments, it should be understood that the ribbon body 100 may have more than one second dye region 130 in actual applications. For example, the ribbon 10 may have a golden second dye region 130 and a silver second dye region 130 at the same time. The silver second dye region 130 and the golden second dye region 130 may be arranged on one side of the first dye regions 121, 122 and 123 and near the protecting dye region 140 along the direction D, but the present disclosure is not limited to such a configuration.

With continued reference made to FIG. 1, the protecting dye region 140 is also arranged on one side of the second dye region 130 along the direction D. In other words, the second dye region 130 in FIG. 1 is located between the protecting dye region 140 and the first dye regions 121, 122 and 123. The protecting dye region 140 has a transparent protecting dye thereon. The transparent protecting dye can cover the dyes of the first dye regions 121, 122 and 123 and/or the dye of the second dye region 130 after the dyes of the first dye regions 121, 122 and 123 and/or the dye of the second dye region 130 are transfer printed onto the printing medium, so as to protect the dyes of the first dye regions 121, 122 and 123 and/or the dye of the second dye region 130.

Again with continued reference made to FIG. 1, in some embodiments, the ribbon 10 further includes a plurality of identification regions 151, 152, 153, 154, 155 and 156, in which each of the first dye regions 121, 122, 123, the second dye region 130 and the protecting dye region 140 is located between two of the identification regions 151 and 152, 152 and 153, 153 and 154, 154 and 155, or 155 and 156. The identification regions 151, 152, 153, 154, 155 and 156 may be coated with black material to thereby be black in color, but the present disclosure is not limited to such a configuration. The identification regions 151, 152, 153, 154, 155 and 156 can be detected by, for example, an optical sensor, so that the sublimation printer to which the ribbon 10 is applied can determine which region of the ribbon body 100 is under the thermal printing head. It should be understood that the above-described and illustrated arrangement positions of the above identification regions 151, 152, 153, 154, 155 and 156 are given by way of example. In actual applications, the shape, color, or arrangement positions of the identification regions 151, 152, 153, 154, 155 and 156 may be different from the embodiment of FIG. 1. Further, the identification method may also be different from the method disclosed in the above embodiment.

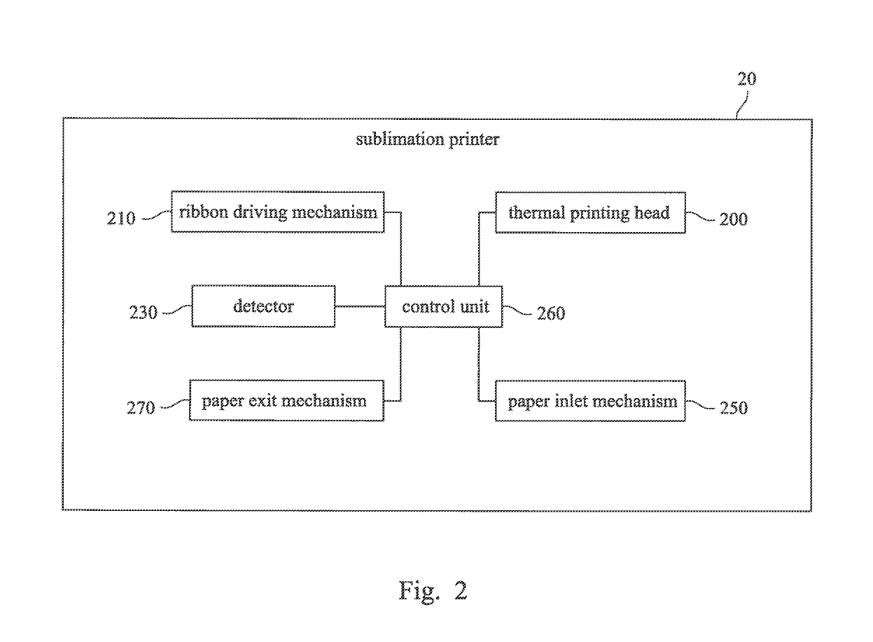

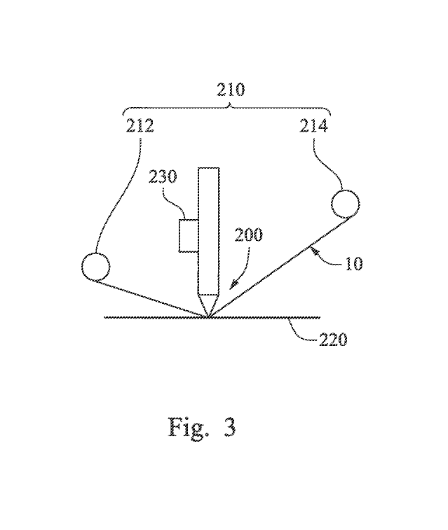

FIG. 2 is a functional block diagram of a sublimation printer 20 in accordance with one embodiment of the present disclosure. FIG. 3 is a schematic view of a thermal printing head 20 shown in a state transfer printing the dye of the ribbon 10 in accordance with one embodiment of the present embodiment. With reference made to FIG. 1 to FIG. 3, the sublimation printer 20 includes a paper inlet mechanism 250, a paper exit mechanism 270, a thermal printing head 200, a detector 230, a ribbon driving mechanism 210 and a control unit 260. The paper inlet mechanism 250 is used to move a printing medium 220, such as an opaque or transparent printing medium. The thermal printing head 200 is used to transfer print at least one of the dyes of the first dye regions 121, 122 and 123 onto the printing medium 220. The ribbon driving mechanism 210 includes a ribbon feeding roller 212 and a ribbon receiving roller 214, which are used to generate a relative movement between the ribbon 10 and the thermal printing head 200. Through using the ribbon driving mechanism 210 to move the ribbon 10, the thermal printing head 200 can heat up different dyes of the first dye regions 121, 122, and 123 so that the dyes of the first dye regions 121, 122, 123 can be heated up and transfer onto the printing medium 220. The detector 230 is used to detect the identification regions 151, 152, 153, 154, 155 and 156 of the ribbon 10. The control unit 260 is used to control the operation of the paper inlet mechanism 250, the thermal printing head 200, the detector 230 and the ribbon driving mechanism 210.

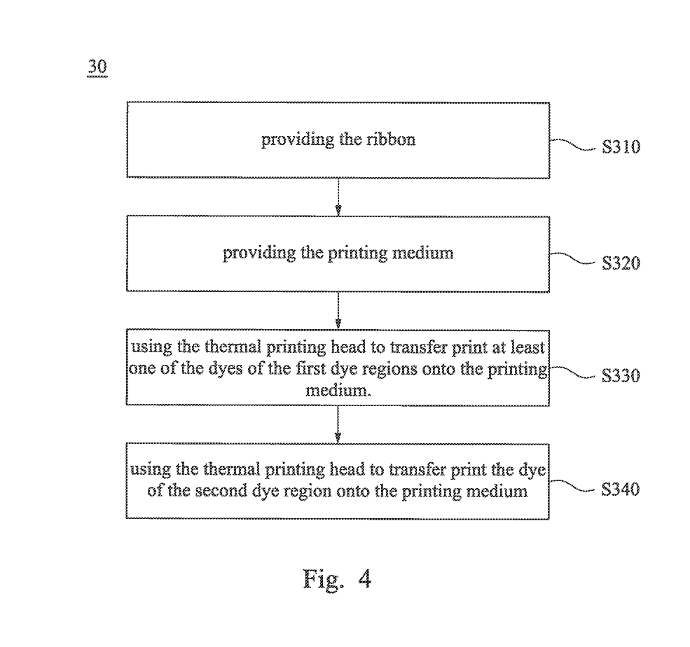

FIG. 4 is a flow chart of a photograph printing method 30 in accordance with one embodiment of the present disclosure. Referring to FIG. 1 to FIG. 4, the photograph printing method 30 includes the following steps (it should be understood that the order of the steps described in the present embodiment, unless otherwise specified, may be changed as required, or the steps or part of the steps may be performed simultaneously):

Step S310: providing the ribbon 10.

Step S320: providing the printing medium 220.

Step S330: using the thermal printing head 200 to transfer print at least one of the dyes of the first dye regions 121, 122 and 123 onto the printing medium 220.

Step S340: using the thermal printing head 220 to transfer print the dye of the second dye region 130 onto the printing medium 220.

In step S310, the ribbon 10 includes a plurality of first dye regions 121, 122 and 123 and at least one second dye region 130. The first dye regions 121, 122 and 123 and the second dye region 130 are sequentially arranged on the ribbon body 100 along the direction D. In some embodiments, the dye of the first dye regions 121, 122 and 123 and the dye of the second dye region 130 can be formed on the ribbon body 100 by gravure printing, blade coating or slot coating, but the present disclosure is not limited in this regard.

In step S320, the printing medium 220 can be an opaque or transparent photographic paper according to actual requirements.

The dyes of the first dye regions 121, 122 and 123 and the dye of the second dye region 130 can be printed on the same face of the printing medium 220, and if the printing medium 220 is an opaque photographic paper, the dye of the second dye region 130 can partially cover the dyes of the first dye regions 121, 122, 123 so that a user can immediately see the color of the dye of the second dye region 130, but is unable to see the color of the mixed dyes of the first dye regions 121, 122, 123 that are covered by the dye of the second dye region 130.

In some embodiments, the dye of the second dye region 130 has a higher gloss than the printing medium (for example, photographic paper). As a result, when the dye of the second dye region 130 is transfer printed onto the printing medium 220, lace patterns that may be printed by the dye of the second dye region 130 can produce a shiny visual effect. Further, if the printing medium 220 is a transparent photographic paper, after the dyes of the first dye regions 121, 122, 123 are transfer printed onto the printing medium 220, the dye of the second dye region 130 can substantially entirely cover the dye of the first dye regions 121, 122 and 123. Since the dye of the second dye region 130 has a higher gloss or reflectivity, when a user views the transparent printing medium 220 from the other face (the face without printing dyes), the image of the printing medium 220 tends to have good brightness. In other words, the dyes of the first dye regions 121, 122 and 123 are now disposed on a high gloss or a high reflectivity material, i.e., on the dye of the second dye region 130, and further the transparent printing medium 220 is like a transparent protecting film, which further enhances the brightness of the images.

In step 330, the thermal printing head 220 transfer prints dyes of at least one of the first dye regions onto the printing medium 220. As an example, the dyes of the first dye regions 121, 122, 123 may be respectively magenta, cyan or yellow color. If the thermal printing head 200 only transfer prints one color onto the printing medium 220, then a user can immediately see that color. If the thermal printing head 200 transfers prints and overlaps different colors onto the printing medium 220, then different colors can be mixed with each other.

In step S340, the thermal printing head 200 transfer prints the dye of the second dye region 130 onto the print medium, in which the dye of the second dye region 130 may at least partially cover the dyes of the first dye regions 121, 122 and 123.

In some embodiments, step 340 which transfer prints the dye of the second dye region 130 onto the printing medium 220 further includes:

(3.1) determining a color mixing result of at least one of the dyes of the first dye regions 121, 122, 123 when transfer printing the same onto the printing medium 220; and

(3.2) adjusting a heating time of the thermal printing head 200 when heating the dye of the second dye region 130 according to the color mixing result.

More specifically, during the process of transfer printing the dyes of the second dye region 130, the adhesion effect of the dye of the second dye region 130 is affected by the color depth of the printing medium 220. For example, if the color of the dye of the second dye region 130 is silver, then the adhesion ability of silver dye is different on a dark color area and on the light color area, that is, the adhesion ability of silver dye on a dark color area is better than on a light color area. Thus, in some embodiments, before transfer printing the dye of the second dye region 130, the color mixing result on the printing media 200 needs to be determined first. For example, for performing the transfer printing of the dye of the second dye region 130 onto the printing media 220 having a predetermined tone, i.e., a gray tone, a predetermined heating time is needed. When the color on the printing media is darker than gray, the heating time of the thermal printing head 220 needs to less than the predetermined heating time for transfer printing the dye of the second dye region 130, so as to avoid excessive silver dye from being transfer printed onto the printing media 220. On the other hand, when the color on the printing media is lighter than gray, the heating time of the thermal printing head 220 needs to greater than the predetermined heating time for transfer printing the dye of the second dye region 130, so as to avoid an excessively small amount of silver dye from being transfer printed onto the printing media 220.

As discussed above, in addition to including the first dye regions used to mixed color, the ribbon of the present disclosure further includes a second dye region, and the dye of the second dye region is unable to mix with the dye of the first dye region. As a result, when the dye of the second dye region covers the dyes of the first dye regions, there is a greater distinction between the dye of the second dye region and the dyes of the first dye regions so that after the dyes of the first and second dye regions are all transfer printed onto a printing medium, the dye of the second dye region is not mistaken by a user as a part of the dyes of the first dye regions.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A ribbon, comprising:
a ribbon body,
a plurality of first dye regions sequentially arranged on the ribbon body, wherein dyes of the first dye regions are able to mix with each other;
at least one second dye region arranged on a side of the plurality of the first dye regions, wherein a dye of the second dye region is unable to mix with the dyes of the first dye regions; and
a protecting dye region, wherein the second dye region is disposed between the protecting dye region and the plurality of the first dye regions.

2. The ribbon of claim 1, further comprising a plurality of identification regions, and each of the first dye regions, the second dye region and the protecting dye region is located between two of the identification regions.

3. The ribbon of claim 1, wherein a material of the dye of the second dye region comprises metal.

4. The ribbon of claim 1, wherein a color of the dye of the second dye region comprises gold or silver.

5. The ribbon of claim 1, wherein the first dye regions comprise a yellow dye region, a magenta dye region and a cyan dye region.

6. A photograph printing method, comprising:
providing a ribbon, the ribbon comprising a plurality of first dye regions sequentially arranged on the ribbon and at least one second dye region arranged on a side of the plurality of the first dye regions, wherein dyes of the first dye regions are able to mix with each other, and a dye of the second dye region is unable to mix with the dyes of the first dye regions;
providing a printing medium;
using a thermal printing head to transfer print at least one of the dyes of the first dye regions onto the printing medium; and
using the thermal printing head to transfer print the dye of the second dye region onto the printing medium.

7. The photograph printing method of claim 6, wherein the step of transfer printing the dye of the second dye region onto the printing medium further comprises making the dye of the second dye region at least partially cover the dyes of the first dye regions which are printed on the printing medium.

8. The photograph printing method of claim 7, wherein the step of transfer printing the dye of the second dye region onto the printing medium further comprises making the dye of the second dye region entirely cover the dyes of the first dye regions which are printed on the printing medium.

9. The photograph printing method of claim 7, wherein the step of transfer printing the dye of the second dye region onto the printing medium further comprises:
determining a color mixing result of at least one of the dyes of the first dye regions when transfer printing the at least one of the dyes of the first dye regions onto the printing medium; and
adjusting a heating time of the thermal printing head when heating the dye of the second dye region according to the color mixing result.
